(19) United States
(12) Patent Application Publication
(10) Pub. No.: US 2009/0254451 A1
(43) Pub. Date: Oct. 8, 2009

(54) Transaction system and method

(76) Inventor: Kfir ADAM, Oranit (IL)

Correspondence Address: Pearl Cohen Zedek Latzer, LLP, 1500 Broadway, 12th Floor, New York, NY, 10036, US

(21) Appl. No.: 11/629,199

(22) PCT Filed: Jun. 14, 2005
(86) PCT No.: PCT/IL05/00622

§ 371 Date: Apr. 15, 2008

Related U.S. Application Data
(60) Provisional application No. 60/578,852, filed on Jun. 14, 2004.

(51) Int. Cl. G06Q 30/00

(52) U.S. Cl. 705/27; 705/35

(57) ABSTRACT

A method for electronic transaction method comprising: selling by a Credit Provider to a Service Provider credit vouchers, each voucher associated with a predetermined value and all the credit cards parameters; electronically distributing by the Service Provider of the vouchers to Merchants, who sell vouchers to End Users, for the End Users to use the vouchers in commercial transactions.

### FIELD OF THE INVENTION

The present invention relates to financial transactions. More particularly it relates to a network-based prepaid Electronic transaction method and electronic vouchers distribution system.

### BACKGROUND OF THE INVENTION

Mainly credit and debit card and various electronic wallets do payments over the Internet.

The disadvantage of these solutions are the high vulnerability for fraud, exposure of the credit card over a public network, lack of anonymity-for the user and high acquiring commissions and expensive charge backs for the Merchant, Although most of the money in the world is rolling by cash, there is no way to pay by cash, which is physical, to virtual Merchants, which are by definition, accepting payments electronically.

The present invention is combining electronic voucher distribution (EVD) system, which collects cash money in a prepaid manner, with the credit/debit cards clearing system.

This invention is a bridge between the cash and the virtual world.

### BRIEF DESCRIPTION OF THE PRESENT INVENTION

There is thus provided, according to some preferred embodiments of the present invention, a method for electronic transaction method, the method comprising:

selling by a Credit Provider to a Service Provider credit vouchers, each voucher associated with a predetermined value;
electronically distributing by the Service Provider of the vouchers to Merchants, who sell vouchers to End Users, for the End Users to use the vouchers in commercial transactions.

Furthermore, in accordance with some preferred embodiments of the present invention, the vouchers are used by End Users in internet transactions.

Furthermore, in accordance with some preferred embodiments of the present invention, the step of electronically distributing by the Service Provider of the vouchers to Merchants comprises:

buying of vouchers by a Merchant requesting vouchers in predetermined face-values from the Service Provider;
electronically transmitting details relating to the vouchers from the Service Provider to a terminal of the Merchant.

Furthermore, in accordance with some preferred embodiments of the present invention, the terminal is an EFT POS.

Furthermore, in accordance with some preferred embodiments of the present invention, the terminal is a mobile phone.

Furthermore, in accordance with some preferred embodiments of the present invention, the terminal is a cash register with communication facility.

Furthermore, in accordance with some preferred embodiments of the present invention, the Merchants pay for the vouchers using credit cards.

Furthermore, in accordance with some preferred embodiments of the present invention, the Merchants pay for the vouchers in advance.

Furthermore, in accordance with some preferred embodiments of the present invention, the End Users pay for the vouchers using credit cards.

Furthermore, in accordance with some preferred embodiments of the present invention, there is provided a system for electronic transaction, the system comprising:

at least one server for electronically distributing through terminals by a Service Provider of vouchers of predetermined values to Merchants, who sell vouchers to End Users, for the End Users to use the vouchers in commercial transactions.

Furthermore, in accordance with some preferred embodiments of the present invention, the server is adapted to control credit limits associated with Merchants, to manage transaction flow, to manage inventory of vouchers.

Furthermore, in accordance with some preferred embodiments of the present invention, the terminals comprise application that includes communication with the server, and display for displaying details associated with the vouchers.

Furthermore, in accordance with some preferred embodiments of the present invention, the terminals further comprise printers for printing the details.

Furthermore, in accordance with some preferred embodiments of the present invention, the Service Provider may require and receive the credit vouchers in offline method and store them and manage the inventory of different face values.

Furthermore, in accordance with some preferred embodiments of the present invention, the Service Provider may require and receive the credit vouchers with different face values in online method and provide them to the merchants on real-time basis.

Furthermore, in accordance with some preferred embodiments of the present invention, the Credit Provider assigns the credit vouchers with some or all of a credit card features.

Furthermore, in accordance with some preferred embodiments of the present invention, the Credit Provider assigns the credit vouchers with some or all of a debit card features.

### BRIEF DESCRIPTION OF THE FIGURES

In order to better understand the present invention, and appreciate its practical applications, the following Figures are provided and referenced hereafter. It should be noted that the Figures are given as examples only and in no way limit the scope of the invention. Like components are denoted by like reference numerals.

FIG. 1 is a block diagram showing general view of a system according to a preferred embodiment of the present invention.

FIG. 2 is a block diagram showing a transaction flow according to a preferred embodiment of the present invention.

### DETAILED DESCRIPTION OF PREFERRED EMBODIMENTS

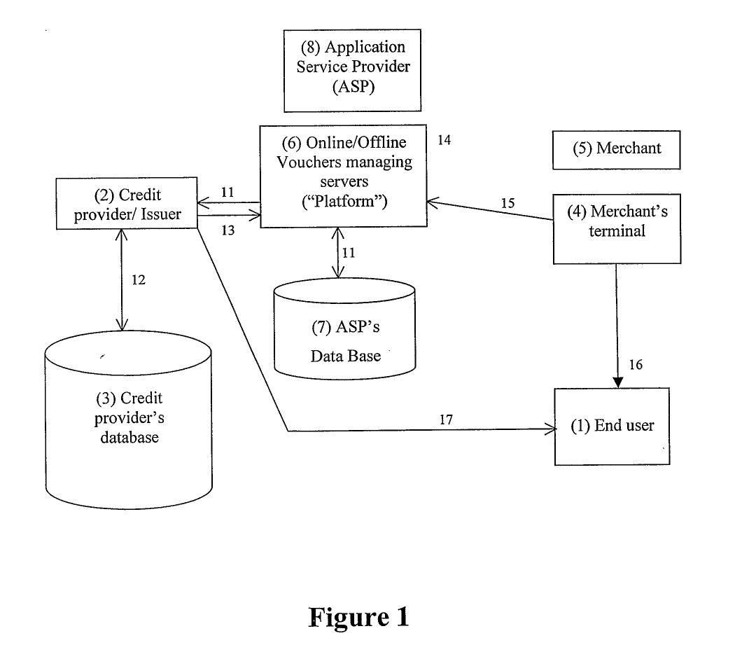

The present invention is combining electronic voucher distribution (EVD) system (see FIG. 1), which collects cash money in a prepaid manner, with the credit/debit cards clearing system.

According to a preferred embodiment of the present invention End Users (1) buys prepaid and anonymous debit card (hereinafter “INTERNET MONEY”) in regular shops. This INTERNET MONEY debit card is issued by authorized Issuer (Credit Provider) (2) and contains all the required details (such as BIN number, expiry date, CVV2 etc.) to be used in virtual Internet purchase.

The INTERNET MONEY debit card is issued and its number, prepaid value and details are stored in the Credit Provider's database (3).

Every shop that is a part of the electronic distribution network is equipped with a terminal (4). The terminal has software that may communicate to the central server of the Service provider and ask to withdraw INTERNET MONEY debit card upon shopper's request.

The central server sends the INTERNET MONEY debit card's details electronically to the terminal. The INTERNET MONEY debit card's details are given to the End User the Merchant (5). The End User can pay in cash for the INTERNET MONEY debit card. The end-user may use it for purchasing in the Internet.

The management of the debit card is done by its Issuer.

The system of the present invention comprises of a centralized computerized platform that contains server software for the EVD and communication apparatus to communicate with the EVD's terminals (hereinafter—‘Platform’) (6) and Data Base (7), which resides at the Application Service Provider (ASP) (8) premises and which communicates with both credit companies and Merchants utilizing the Terminals.

The Terminals can be implemented by existing communication and Electronic Fund Transfer Point Of Sale (EFT POS) means, mobile phones with Java applications or WAP or by SMS, or any terminal that may contain software, user interface and data communication means to communicate with the Platform.

The ASP platform is built out of a single or a cluster of servers containing application (either software or hardware or both) which performs the specified actions, deals with authorizations and controls over these actions and governs the process. The platform may be deployed in either centralized or distributed configuration (i.e. on a single server or over a cluster of servers).

At first the ASP transfers money to the credit card company using standard transferring methods (11).

The credit company than divides the lump sum into predefined quotas and each quota is associated with a PIN-code and store it in its Data base (12). This is the stage where INTERNET MONEY is created, and a debit, limited amount, PIN based electronic voucher is produced.

The credit company transfers a list of the INTERNET MONEY vouchers back to the ASP's platform which then handles and manages the e-vouchers (13). The platform also manages the Merchants' handling, thus, but not limiting the present invention to this list, Merchant acquisition, Merchant profiling, movement tracking, Inventory, clearing and reports are all functions executed by the platform. Based on ASP arrangement (in advance) with the Merchants, a Merchant then becomes ‘authorized’ (preferably those Merchants that meet predetermined criteria) (14).

The INTERNET MONEY is distributed through the platform to the authorized Merchants' Terminals using a proprietary protocol (15).

The Merchant then sells the INTERNET MONEY to End User (16). The End User receives a voucher representing a Debit-like card with associated PIN-code, which he then uses it as any regular credit/debit card at all type of virtual, Internet or real life stores.

An INTERNET MONEY voucher has a lot of benefits, among them are listed the following:
It keeps the End User anonymous while purchasing in the Internet. The End User does not expose his credit card details at all.
The Merchant does not keep a stock of INTERNET MONEY vouchers in the store. He may download INTERNET MONEY vouchers online.
The Credit Provider creates a prepaid Debit card with no risk for chargebacks.
The virtual store can carry out clearing of debit cards with standard tools by all members of the Visa's, MasterCard's and other credit card firms.

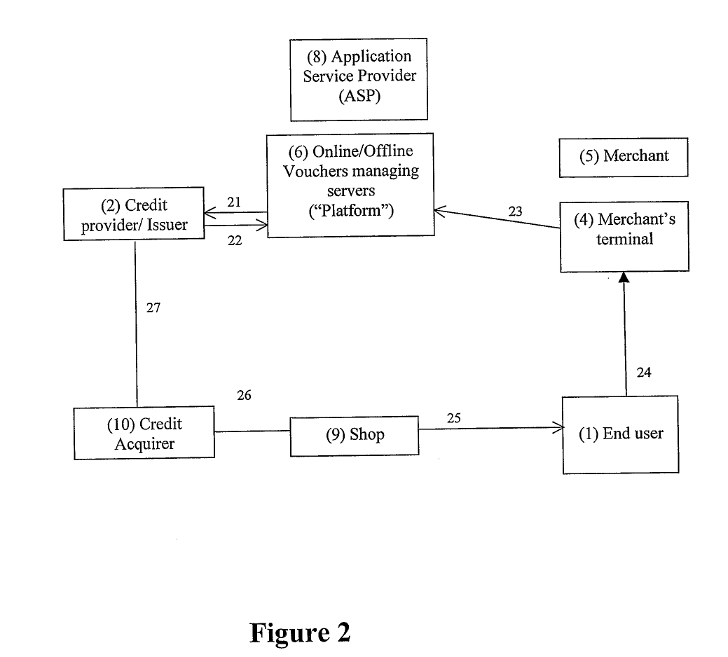

Reference is now made to the FIG. 2, representing the different stages according to a preferred embodiment of the method of the present invention.

### Step I

The ASP transfers money to the credit company (21) and in return receives the same amount after it is divided to predefined vouchers (‘INTERNET MONEY) value (e.g. 95 $) with associated PIN-codes (22).

The ASP handles and distributes the INTERNET MONEY (with the associated PIN-codes) to authorized Merchants' EFT POS (23). INTERNET MONEY is sold for a value which includes the ASP marginal profit (e.g. for 97.5$ compared with the above mentioned voucher price)

The End User buys the INTERNET MONEY at the selling points for a price that includes the Merchants' marginal profit (e.g. for 100 $ compared with the above mentioned voucher price) (24). The PIN-codes are transmitted to the Merchants' EFT POS and then printed or handwritten on a paper and are handed over to the End User.

The End User then uses the INTERNET MONEY vouchers at any of the stores that accept this as a method of payment, both physical shops and virtual space shops (9) while the INTERNET MONEY functions as any regular debit card number (25).

The nominal value of the voucher (i.e. the total sum that the user can use to purchase with the card) remains 95$, while 5$ were paid to the ASP and the Merchant.

The transaction data and money are then flow from the Credit Acquirer (10) to the Issuer in a standard manner (25,26,27).

The vouchers, according to a preferred embodiment of the invention may be limited in time, and expire after a predetermined period of time has lapsed.

It should be clear that the description of the embodiments and attached Figures set forth in this specification serves only for a better understanding of the invention, without limiting its scope.

It should also be clear that a person skilled in the art, after reading the present specification could make adjustments or amendments to the attached Figures and above described embodiments that would still be covered by the present invention.

1. A method for electronic transaction method, the method comprising:
selling by a Credit Provider to a Service Provider credit vouchers, each voucher associated with a predetermined value and all the credit cards parameters;
electronically distributing by the Service Provider of the vouchers to Merchants, who sell vouchers to End Users, for the End Users to use the vouchers in commercial transactions.

2. The method of claim 1, wherein the vouchers are used by End Users in internet transactions.

3. The method of claim 1, wherein the step of electronically distributing by the Service Provider of the vouchers to Merchants comprises:
buying of vouchers by a Merchant requesting vouchers in predetermined face-values from the Service Provider;
electronically transmitting details relating to the vouchers from the Service Provider to a terminal of the Merchant.

4. The method of claim 3, wherein the terminal is an EFT POS.

5. The method of claim 3, wherein the terminal is a mobile phone.

6. The method of claim 3, wherein the terminal is a cash register with communication facility.

7. The method of claim 1, wherein the Merchants pay for the vouchers using credit cards.

8. The method of claim 1, wherein the Merchants pay for the vouchers in advance.

9. The method of claim 1, wherein the End Users pay for the vouchers using credit cards.

10. A system for electronic transaction, the system comprising:
at least one server for electronically distributing of vouchers with predetermined values through terminals to Merchants, who sell vouchers to End Users, for the End Users to use the vouchers in commercial transactions.

11. The system of claim 10, wherein the server is adapted to control credit limits associated with Merchants, to manage transaction flow and to manage inventory of vouchers.

12. The system of claim 10, wherein the terminals comprise application that includes communication with the server, and display for displaying details associated with the vouchers.

13. The system of claim 12, wherein the terminals further comprise printers for printing the details.

14. The system of claim 10, wherein the terminals comprise mobile phones.

15. The system of claim 14, wherein the terminals comprise mobile phones with ability to run WAP or J2ME application.

16. The system of claim 10, wherein the terminals comprise EFT POS with wireless or landline data communication ability.

17. The system of claim 10, wherein said at least one server further comprises at least one data base for storing voucher data for off-line use.

18. The system of claim 10, wherein said at least one server works online and provide the Merchant with INTERNET MONEY vouchers per demand on real time basis.
